(19) United States
(12) Patent Application Publication
(10) Pub. No.: US 2025/0021430 A1
(43) Pub. Date: Jan. 16, 2025

(54) METADATA TRANSFER USING UNASSIGNED CODES OF AN ENCODER

(71) Applicant: Micron Technology, Inc., Boise, ID (US)

(72) Inventors: Casto Salobrena Garcia, Munich (DE); Thomas Hein, München (DE); Michael Dieter Richter, Ottobrunn (DE)

(21) Appl. No.: 18/764,003

(22) Filed: Jul. 3, 2024

Related U.S. Application Data
(60) Provisional application No. 63/526,149, filed on Jul. 11, 2023.

(51) Int. Cl. G06F 11/10

(52) U.S. Cl. CPC G06F 11/1016; G06F 11/1004

(57) ABSTRACT

Methods, systems, and devices for metadata transfer using unassigned codes of an encoder are described. The method may include inputting data and metadata associated with the data into an encoder. The data may include a first set of codewords modulated using a first modulation scheme including symbols that each represent one bit of digital information. Further, the method may include generating, using the encoder, a first subset of a second set of codewords representative of the data and a second subset of the second set of codewords representative of the metadata. The second set of codewords may be modulated using a second modulation scheme including symbols that each represent more than one bit of digital information. Further, the method may include transmitting the data and the metadata using the second set of codewords.

### CROSS REFERENCE

The present Application for Patent claims priority to U.S. Patent Application No. 63/526,149 by Salobrena Garcia et al., entitled “METADATA TRANSFER USING UNASSIGNED CODES OF AN ENCODER,” filed Jul. 11, 2023, which is assigned to the assignee hereof, and which is expressly incorporated by reference in its entirety herein.

### TECHNICAL FIELD

The following relates to one or more systems for memory, including metadata transfer using unassigned codes of an encoder.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports metadata transfer using unassigned codes of an encoder in accordance with examples as disclosed herein.

FIG. 2 shows an example of a system that supports metadata transfer using unassigned codes of an encoder in accordance with examples as disclosed herein.

FIG. 3 shows a block diagram of a memory system or a host system that supports metadata transfer using unassigned codes of an encoder in accordance with examples as disclosed herein.

FIGS. 4 and 5 show flowcharts illustrating a method or methods that support metadata transfer using unassigned codes of an encoder in accordance with examples as disclosed herein.

### DETAILED DESCRIPTION

A first device (e.g., a memory system or a host system) may transmit data to a second device (e.g., a memory system or a host system). Prior to transmitting the data, the first device may input the data into a first encoder (e.g., a lossless encoder). The first encoder may prepare the data for transmission by changing the modulation scheme of the data. In some examples, the encoder may be an example of a binary to ternary lossless encoder. A binary to ternary lossless encoder may transform the data from being modulated according to a binary-symbol modulation scheme (e.g., 1 bit per symbol) to being modulated according to a ternary-symbol modulation scheme (e.g., 1.5 bits per symbol).

When modulated according to the binary-symbol modulation scheme, the data may be mapped to a first set of codewords. The first set of codewords may represent all of the possible bit combinations for a given number of symbols modulated according to binary-symbol modulation. For example, the possible bit combinations for 1 symbol in a binary-modulation scheme may be 0 or 1 resulting in 2¹ possible combinations of unique codewords (e.g., 2 possible combinations of unique codewords). In another example, the possible bit combinations for 8 symbols in a binary-modulation scheme may result in 2⁸ possible combinations of unique codewords (e.g., 256 possible combinations of unique codewords). During encoding, the first encoder may generate a second set of codewords associated with ternary-symbol modulation. The second set of codewords may represent all of the possible trit combinations for a given number of symbols modulated according to ternary-symbol modulation. For example, the possible trit combinations for 1 symbol in a ternary-modulation scheme may be 0, −1 , or +1 resulting in 3¹ possible combinations of unique codewords (e.g., 3 possible combinations of unique codewords). In another example, the possible bit combinations for 8 symbols in a binary-modulation scheme may result in 3⁸ possible combinations of unique codewords (e.g., 6561 possible combinations of unique codewords).

Further, the first encoder may map each codeword of the first set of codewords to a codeword of the second set of codewords. The first device may transmit the data to the second device via a first channel using a corresponding codeword of the second set of codewords. However, the quantity of codewords in the first set of codewords may be different than the quantity of codewords in the second of codewords resulting in at least one unassigned codeword in the second set of codewords (e.g., at least one codeword in the second set of codewords that is not mapped to a codeword of the first set of codewords). For example, if each codeword of the first set of codewords associated with the binary modulation scheme includes three bits (e.g., 2³=8 possible codewords) and each codeword of the second set of codewords associated with the ternary modulation include three trits (e.g., 3³=9 possible codewords), there will be one unassigned (e.g., unmapped) codeword in the second set of codewords. The quantity of unassigned codewords in the second set of codewords may depend on the mapping. In other examples, the first set of codewords may include eleven bits (e.g., 2¹¹=2048 possible codewords) and the second set of codewords may include seven trits (e.g., 3⁷=2187 possible codewords), which results in 139 unassigned codewords in the second set of codewords.

The unassigned codewords in the second set of codewords associated with the ternary modulation scheme may present opportunities for communicating metadata. In some memory systems (e.g., systems that only use binary modulation schemes), data and metadata may be communicated in a rigid manner. In some cases, that may result in inefficient use of communication resources. For example, if the data includes errors such that the data is poisoned, a system may communicate the data and separately communicate all of the metadata associated with the data. As soon as the receiver receives the metadata, it may be determined that data is poisoned, and the data may be discarded. Using the ternary modulation scheme with unassigned codewords

As described herein, the transmitting device may utilize at least one unassigned codeword for metadata in certain circumstances and reduce a total quantity communication and thereby improve the efficiency of the communication channel. For example, the first device may identify data to transmit to a receiver and generate metadata for the data. The metadata may indicate one or more characteristics of the data. In some instances, the metadata may indicate that the data is invalid (e.g., error correction code (ECC) failure flag). In an effort to improve bandwidth, as opposed to encoding and transmitting both the data and the metadata, the first device may encode the metadata and the data using a single encoder (e.g., the first encoder). During encoding, the first device may utilize the single encoder to map the data to a first portion of the codewords included in the second set of codewords and map the metadata to a second portion of the codewords included in the second set of codewords. In some circumstances, the metadata may indicate information such that transmitting some of the data and/or the metadata may be able to be skipped. For example, if the metadata indicates that the data is invalid and should be discarded, the encoder may map that metadata to a codeword of the second portion of the codewords. The encoder may then replace one codeword associated with the data with the codeword of the metadata. Upon receiving the unique codeword as part of the transmission of the data, the receiver may be able to identify the data is invalid. Such conditions may make the transmission of the metadata and/or other portions of the data redundant. By using a single encoder to encode both the data and metadata, communication bandwidth previously allocated for metadata (and/or other portions of the data) may be released to be used for other communications.

Features of the disclosure are illustrated and described in the context of systems and architectures. Features of the disclosure are further illustrated and described in the context of systems and flowcharts.

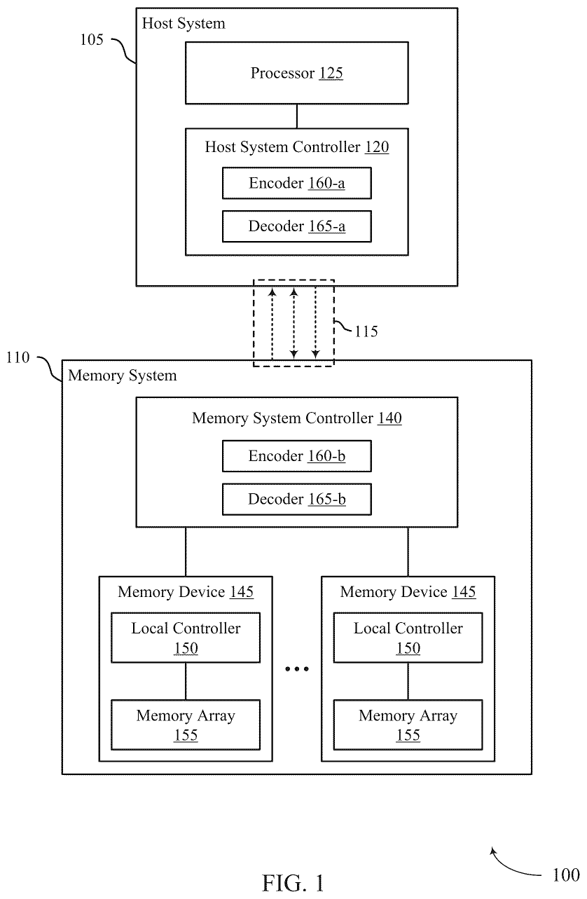

FIG. 1 illustrates an example of a system 100 that supports metadata transfer using unassigned codes of an encoder in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some example, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

As described herein, a first device (e.g., a memory system 110 or a host system 105) may encode metadata and data using a same lossless encoder (e.g., an encoder 160-a or an encoder 160-b) and transmit the metadata and the data to a second device (e.g., a memory system 110 or a host system 105). In some examples, the first device may input the data and the meta data associated with the data into an encoder 160. The data may include a first set of codewords modulated using a first modulation scheme that includes symbols representative of 1 bit of digital information. Using the encoder, the first device may generate a second set of codewords modulated using a second modulation scheme that include symbols representative of more than one bit of information. In some examples, a first subset of the second set of codewords may be representative of the data and a second subset of the second set of codewords may be representative of the metadata. Further, the first device may transmit the data and the metadata via the second set of codewords to the second device (e.g., a memory system 110 or a host system 105) using a transmission line (or channel 115) and the second device may utilize a decoder (e.g., a decoder 165-a or a decoder 165-b) to decode the data and the metadata using similar methods as described with respect to the encoder 160.

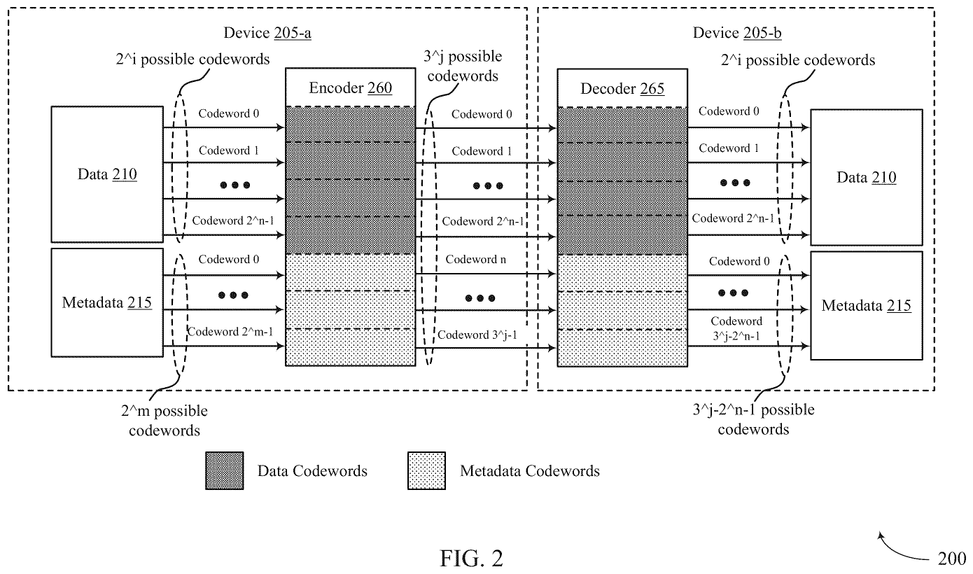

FIG. 2 shows an example of a system 200 that supports metadata transfer using unassigned codes of an encoder in accordance with examples as disclosed herein. In some examples, the system 200 may implement aspects of a system 100. For example, the system 200 may include a device 205-a and a device 205-b which each may be an example of a memory system 110 or a host system 105 as described with reference to FIG. 1.

As described in FIG. 1, a host system and a memory system may perform a read operation. During the read operation, the host system may transmit a read command to the memory system indicating memory cells included in a memory array of the memory system. In response to the read command, the memory system may read logic states stored in the memory cells and transmit data 210 including bits representative of the logic states to the host system. In such example, the memory system may be an example of a device 205-a (e.g., a transmitting device) as described in FIG. 2 and the host system may be an example of a device 205-b (e.g., a receiving device) as described in FIG. 2.

In another example, the host system and a memory system may perform a write operation. During the write operation, the host system may transmit a write command to the memory system that includes data 210 as well as an indication of memory cells included in the memory array of the memory system. Upon receiving the write command, the memory system may store the data 210 in the form of logic states in the memory cells. In such example, the host system may be an example of a device 205-a as described in FIG. 2 and the memory system may be an example of a device 205-a as described in FIG. 2. The host system and a memory system are not an exhaustive list of all of the devices that may be examples of the device 205-a and the device 205-b. A device 205-a may be any device that includes one or more components configurable to transmit data 210 and a device 205-b may be any device that includes one or more components configurable to receive data 210.

In some examples, prior to transmitting the data 210 to the device 205-b, the device 205-a may perform one or more operations on the data 210. For example, the device 205-a man encode the data 210 for transmission using an encoder 260. In some examples, the encoder 260 may be an example of a lossless encoder. A defining characteristic of a lossless encoder may be that a quantity of codewords input into the encoder 260 may be less than or equal to a quantity of codewords output from the encoder 260. In one example, the encoder 260 may be an example of a k-nary to m-nary lossless encoder. For a k-nary to m-nary lossless encoder, the input codewords may be modulated using k-nary modulation and the output codewords may be modulated using m-nary modulation. For k-nary modulation, the data 210 may be mapped kⁿ possible codewords and for m-nary modulation, the data 210 may mapped to mⱼ possible codewords. In such case, kⁿ≤m^{j} to ensure that an input codeword can be mapped to at least one codeword of the output codewords.

In the example of FIG. 2, the encoder 260 may be an example of a binary to ternary lossless encoder. For a binary to ternary lossless encoder, at the input of the encoder 260, the data 210 may be modulated according to a binary-symbol modulation scheme and at the output of the encoder 260, the data 210 may be modulated according to a ternary-symbol modulation scheme. A symbol of the binary-symbol modulation scheme may be operable to represent 1 bit (e.g., a symbol may represent a logic 1 or a logic 0) of the data 210. Thus, the quantity of input codewords (e.g., possible bit combinations for a given number of symbols) may be equal to 2ⁿ for a binary to ternary lossless encoder.

On the other hand, a symbol of a ternary-symbol modulation scheme may be operable to represent three unique states (e.g., −1, 0, 1, sometimes referred to as trits), which equates to about 1.5 bits of the data 210 per symbol. The 1.5 bits may correspond to a trit value of 0, +1, or −1 resulting in a quantity of output codeword (e.g., possible trit combinations for a given number of symbols) equal to 3^{j} for the binary to ternary lossless encoder. In the example of the binary to ternary lossless encoder, the input codewords may be less than output codewords such that each input codewords may map to at least one codeword of output codewords. For example, if n is equal to 3 then j must be equal to at least 2 for a binary to ternary lossless encoder.

However, a consequence of using a lossless encoder or more specifically, a lossless encoder that assigns a first number of quantization stages (e.g., 2 quantization stages) to a second number of quantization stages (e.g., 3 quantization stages), may be that the efficiency of the lossless encoder may be less than 100%. For example, if n is equal to 3 and j is equal to 2 for a binary to ternary lossless encoder, the resulting quantity of input codewords may be 8 and the resulting quantity of output codewords may be 9. The input codewords may map to 8 codewords of the output codewords leaving 1 of the output codewords unused or unassigned (e.g., leaving 3^{j}−2ⁿ codewords unused). In other examples, n is equal to 11 and j is equal to 7 for a binary to ternary lossless encoder, the resulting quantity of input codewords may be 2048 and the resulting quantity of output codewords may be 2187, which results in 139 unassigned codewords in the list of possible output codewords.

As described herein, the device 205-a may utilize the unassigned output codewords for transmitting metadata 215 associated with the data 210. Metadata 215 may provide information about one or more aspects of the data 210. In one example, the metadata 215 may indicate whether an ECC failure has occurred with respect to the data 210. In some examples, after the device 205-a reads the data 210 from the memory cells, the device 205-a may perform an ECC operation on the data 210. When the data 210 is written to the memory cells, a set of parity bits may be generated for the data 210 and stored along with the data 210 in the memory array. When the data 210 is read from the one or more memory cells, the device 205-a may generate a new set of parity bits and compare the new set of parity bits to the set of parity bits stored along with the data 210. If the two sets of parity bits do not match, the device 205-a may detect an ECC failure or an error in the data 210 and generate metadata 215 (e.g., a flag) indicative of the ECC failure (e.g., a severity indication). In some examples, the error may be an uncorrectable error. An uncorrectable error may be an error that is so severe that ECC is unable to correct it (e.g., a multibit error (MBE)). Another type of metadata 215 that may indicate an uncorrectable error may be a poison indication.

When the device 205-a reads the data 210 from the memory cells, the device 205-a may generate the metadata 215 (e.g., ECC failure flag, uncorrectable error indication, data invalidity) and input the data 210 and the metadata 215 in the encoder 260. At the input of the encoder 260, the data 210 may be modulated using the binary-symbol modulation scheme and may be mapped to a first set of codewords (e.g., codewords 0 through 2ⁿ−1). Further, the metadata 215 may be modulated using the binary-symbol modulation scheme and may be mapped to a third set of codewords (e.g., the codewords 0 through 2^{m-1}). In some examples, each codeword in the third set of codewords may correspond to a different type of metadata 215. For example, a codeword in the third set of codewords may indicate the uncorrectable error. Using the encoder 260, the device 205-a may generate a second set of codewords modulated using the ternary-symbol modulation scheme (e.g., the codewords 0 through 3^{j}−1). During the encoding operation, the encoder 260 may map the first set of codewords to a first subset of the second set of codewords (e.g., codewords 0 through 2ⁿ−1) and map at least a subset of the third set of codewords to a second subset of the second set of codewords (e.g., the codewords n through 3^{j}−1).

In some examples, there may not be enough codewords included in the second subset of the second set of codewords to provide a one-to-one mapping between the third set of codewords and the second subset of the second set of codewords. As such, the device 205-a may only map a subset of the third set of codewords to the second subset of the second set of codewords (e.g., the codeword that represents an uncorrectable error).

Table 1 illustrates an encoding table for a binary to ternary encoder 260. In the example of Table 1, the first set of codewords may include 8 (or 23) codewords each represented by three bits and the second set of codewords may include 9 (or 32) codewords each represented by two trit values. During encoding, the first set of codewords may be mapped to 8 of the 9 codewords included in the second set of codewords. For example, a codeword comprising bits 000 may be mapped to a codeword comprising two trits of value 0 and −1. Further, during encoding, at least one codeword of the possible codewords for the metadata 215 (e.g., the codewords 0 through 2^{m}−1) may be mapped to 1 of the 9 codewords included in the second set of codewords. For example, the metadata 215 may be mapped to a codeword comprising two trits of a value of 00 (or the unassigned codeword).

TABLE 1
Encoder/Decoder Table.

| 3 Bits | | |
|---|---|---|
| MSB | LSB | 2 Trits |

| 0 | 0 | 0 | 0 | −1 |
|---|---|---|---|---|
| 0 | 0 | 1 | −1 | +1 |
| 0 | 1 | 0 | +1 | −1 |
| 0 | 1 | 1 | 0 | +1 |
| Metadata | | | 0 | 0 |
| 1 | 0 | 0 | −1 | −1 |
| 1 | 0 | 1 | −1 | 0 |
| 1 | 1 | 0 | +1 | 0 |
| 1 | 1 | 1 | +1 | +1 |

In some examples, the metadata 215 may indicate that the data 210 is valid. In such example, the device 205-a may utilize a different encoder (e.g., an encoder different from the encoder 260) to encode the metadata 215 and transmit the metadata 215 to the device 205-b using a different channel (or transmission line) than the data 210. Alternatively, the metadata 215 may indicate that the data 210 is invalid. In such case, the device 205-a may encode both the metadata 215 and the data 210 using the encoder 260 as described herein. Further, the device 205-a may release any resources previously allocated for the transfer of the metadata 215 (e.g., resources corresponding to the different encoder) and reallocate the resources for other operations.

In some examples, the device 205-a and the device 205-a may identify a mapping between the metadata 215 and at least one codeword of the second set of codewords (e.g., a codeword that is not assigned to the data 210). As an example, the mapping may indicate that a metadata 215 codeword indicating an ECC failure flag may be mapped to the at least one codeword of the second set of codewords. Using the mapping, the encoder 260 may map the ECC failure flag to the at least one codeword of the second set of codewords (e.g., the codeword including 2 trits of value 00 in Table 1) during encoding.

In some examples, the second set of codewords may include more than one unassigned codeword. In such example, the mapping may indicate that different types of metadata 215 may be mapped to different unassigned codewords. For example, the mapping may indicate that a first codeword corresponding to a first type of metadata 215 may be mapped to a first unassigned codeword of the second set of codewords and that a second codeword corresponding to a second type of metadata 215 may be mapped to a second unassigned codeword in the second set of codewords. Additionally or alternatively, more than one type of metadata 215 may be mapped to a same unassigned codeword. For example, the mapping may indicate that a first codeword corresponding to a first type of metadata 215 as well as a second codeword corresponding to a second type of metadata 215 may be mapped to a first unassigned codeword of the second set of codewords. In some examples, the device 205-a and the device 205-a may store the mapping in memory cells of their respective memory arrays.

After generating the second set of codewords, the encoder 260 may transform the data 210 and the metadata 215 from binary-to-ternary and the device 205-a may transmit the data 210 using the codewords of the first subset of the second set of codewords and the metadata 215 using the codewords of the second subset of the second set of codewords to the device 205-b. In some examples, the device 205-a may transmit the data 210 and the metadata 215 via a same channel (or transmission line) using a series of bursts that each include one or more symbols. In some examples, the device 205-a may transmit the metadata 215 using a first burst of the series of burst and the data 210 using a second burst of the series of burst that occurs after the first burst. Transmitting the metadata 215 first with respect to the data 210 may allow the device 205-b to quickly recognize the metadata 215 and potentially disregard the data 210 if the metadata 215 indicates the data 210 is invalid. Additionally, if the data 210 is invalidated and the metadata 215 indicates that, the transmitting device may refrain from transmitting the entire set of metadata in a later burst. Such conditions may allow the transmitting device to repurpose the burst of the metadata for other purposes and thus increase the communication efficiency using these techniques.

Upon receiving the data 210 and the metadata 215, the device 205-b may input the data 210 and the metadata 215 into a decoder 265 and performing decoding on the data 210 and the metadata 215. During decoding, the decoder 265 may map the first subset of the second of codewords (e.g., codewords 0 through 2ⁿ−1) corresponding to the input data 210 to the first set of codewords (e.g., codewords 0 through 2ⁿ−11) to generate the data 210 modulated according to a binary-modulation scheme. Further, the decoder 265 may map unassigned codewords of the second set of codewords (e.g., codewords n through 3^{j}−1) to the subset of the third set of codewords representative of the metadata 215 (e.g., codewords 0 through 3^{j}−2ⁿ−1) using the mapping. In some examples, the device 205-b may disregard the data 210 upon receiving metadata 215 indicating an uncorrectable error or invalid data 210.

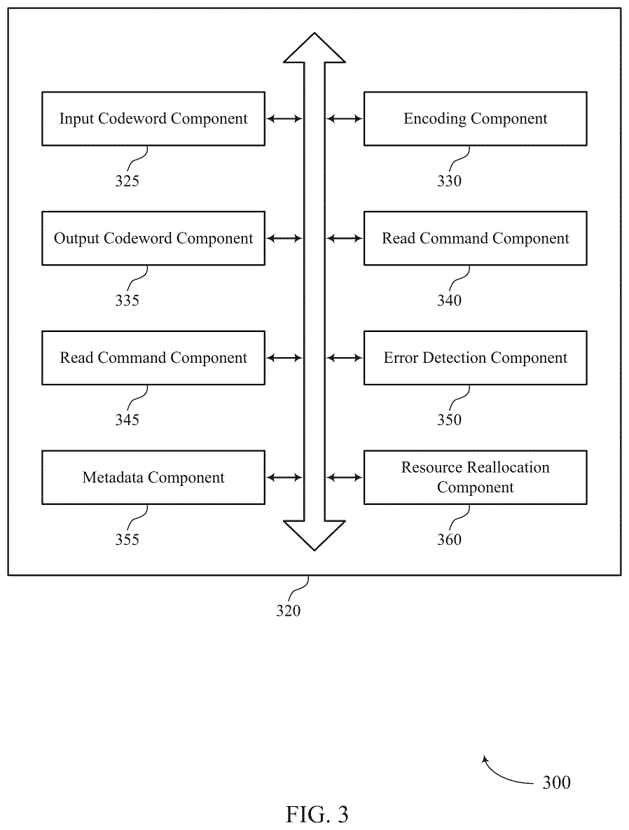

FIG. 3 shows a block diagram 300 of a memory system or host system 320 that supports metadata transfer using unassigned codes of an encoder in accordance with examples as disclosed herein. The memory system or host system 320 may be an example of aspects of a memory system or a host system as described with reference to FIGS. 1 through 2. The memory system or host system 320, or various components thereof, may be an example of means for performing various aspects of metadata transfer using unassigned codes of an encoder as described herein. For example, the memory system or host system 320 may include an input codeword component 325, an encoding component 330, an output codeword component 335, a read command component 340, a read command component 345, an error detection component 350, a metadata component 355, a resource reallocation component 360, or any combination thereof. Each of these components, or components of subcomponents thereof (e.g., one or more processors, one or more memories), may communicate, directly or indirectly, with one another (e.g., via one or more buses).

The input codeword component 325 may be configured as or otherwise support a means for inputting data and metadata associated with the data into an encoder, where the data includes a first set of codewords modulated using a first modulation scheme including symbols that each represent one bit of digital information. The encoding component 330 may be configured as or otherwise support a means for generating, using the encoder, a first subset of a second set of codewords representative of the data and a second subset of the second set of codewords representative of the metadata based at least in part on inputting the data and the metadata into the encoder, the second set of codewords modulated using a second modulation scheme including symbols that each represent more than one bit of digital information, where a first quantity of the first set of codewords associated with the first modulation scheme is less than a second quantity of the second set of codewords associated with the second modulation scheme. The output codeword component 335 may be configured as or otherwise support a means for transmitting the data using the first subset of the second set of codewords and the metadata using the second subset of the second set of codewords.

In some examples, the read command component 340 may be configured as or otherwise support a means for receiving a read command associated with the data. In some examples, the read command component 345 may be configured as or otherwise support a means for reading the data from one or more memory cells of a memory device based at least in part on receiving the read command, where inputting the data and the metadata into the encoder is based at least in part on reading the data.

In some examples, the error detection component 350 may be configured as or otherwise support a means for detecting one or more errors in the data based at least in part on performing an error control operation on the data. In some examples, the metadata component 355 may be configured as or otherwise support a means for generating the metadata based at least in part on detecting the one or more errors in the data, where the metadata indicates that the data is invalid.

In some examples, to support transmitting the metadata and the data, the output codeword component 335 may be configured as or otherwise support a means for transmitting the metadata and the data via a same channel using a set of symbols modulated according to the second modulation scheme.

In some examples, the encoding component 330 may be configured as or otherwise support a means for identifying a mapping between the metadata and a symbol of the set of symbols, where transmitting the metadata is based at least in part on the mapping.

In some examples, to support transmitting the metadata and the data, the output codeword component 335 may be configured as or otherwise support a means for transmitting a first subset of the set of symbols representative of the metadata prior to transmitting a second subset of the set of symbols representative of the data.

In some examples, the resource reallocation component 360 may be configured as or otherwise support a means for reallocating resources associated with the metadata based at least in part on the metadata including an indication that the data is invalid.

In some examples, a third quantity of the first subset of the second set of codewords associated with the second modulation scheme is equal to the first quantity of codewords associated with the first modulation scheme.

In some examples, a fourth quantity of the second subset of the second set of codewords associated with the second modulation scheme is equal to a difference between the second quantity of codewords and the third quantity of codewords. In some examples, the second subset of the second set of codewords includes unassigned codewords corresponding to the second modulation scheme. In some examples, the first modulation scheme includes a binary-symbol modulation scheme and the second modulation scheme includes a ternary-symbol modulation scheme.

In some examples, the described functionality of the memory system or host system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system or host system 320, or various components thereof, may be implemented at least in part by instructions (e.g., stored in memory, non-transitory computer-readable medium) executable by such at least one processor.

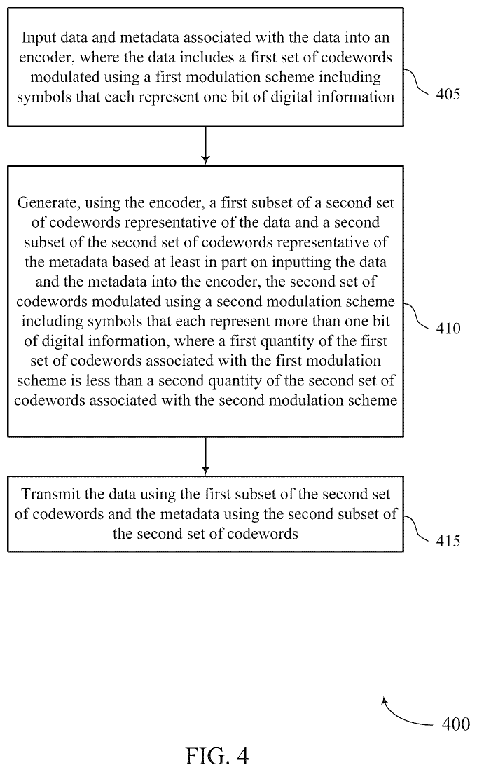

FIG. 4 shows a flowchart illustrating a method 400 that supports metadata transfer using unassigned codes of an encoder in accordance with examples as disclosed herein. The operations of method 400 may be implemented by a memory system or a host system or its components as described herein. For example, the operations of method 400 may be performed by a memory system or a host system as described with reference to FIGS. 1 through 3. In some examples, a memory system or a host system may execute a set of instructions to control the functional elements of the device to perform the described functions. Additionally, or alternatively, the memory system or the host system may perform aspects of the described functions using special-purpose hardware.

At 405, the method may include inputting data and metadata associated with the data into an encoder, where the data includes a first set of codewords modulated using a first modulation scheme including symbols that each represent one bit of digital information. In some examples, aspects of the operations of 405 may be performed by an input codeword component 325 as described with reference to FIG. 3.

At 410, the method may include generating, using the encoder, a first subset of a second set of codewords representative of the data and a second subset of the second set of codewords representative of the metadata based at least in part on inputting the data and the metadata into the encoder, the second set of codewords modulated using a second modulation scheme including symbols that each represent more than one bit of digital information, where a first quantity of the first set of codewords associated with the first modulation scheme is less than a second quantity of the second set of codewords associated with the second modulation scheme. In some examples, aspects of the operations of 410 may be performed by an encoding component 330 as described with reference to FIG. 3.

At 415, the method may include transmitting the data using the first subset of the second set of codewords and the metadata using the second subset of the second set of codewords. In some examples, aspects of the operations of 415 may be performed by an output codeword component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for inputting data and metadata associated with the data into an encoder, where the data includes a first set of codewords modulated using a first modulation scheme including symbols that each represent one bit of digital information; generating, using the encoder, a first subset of a second set of codewords representative of the data and a second subset of the second set of codewords representative of the metadata based at least in part on inputting the data and the metadata into the encoder, the second set of codewords modulated using a second modulation scheme including symbols that each represent more than one bit of digital information, where a first quantity of the first set of codewords associated with the first modulation scheme is less than a second quantity of the second set of codewords associated with the second modulation scheme; and transmitting the data using the first subset of the second set of codewords and the metadata using the second subset of the second set of codewords.

Aspect 2: The method, apparatus, or non-transitory computer-readable medium of aspect 1, further including operations, features, circuitry, logic, means, or instructions, or any combination thereof for receiving a read command associated with the data and reading the data from one or more memory cells of a memory device based at least in part on receiving the read command, where inputting the data and the metadata into the encoder is based at least in part on reading the data.

Aspect 3: The method, apparatus, or non-transitory computer-readable medium of any of aspects 1 through 2, further including operations, features, circuitry, logic, means, or instructions, or any combination thereof for detecting one or more errors in the data based at least in part on performing an error control operation on the data and generating the metadata based at least in part on detecting the one or more errors in the data, where the metadata indicates that the data is invalid.

Aspect 4: The method, apparatus, or non-transitory computer-readable medium of any of aspects 1 through 3, where transmitting the metadata and the data includes operations, features, circuitry, logic, means, or instructions, or any combination thereof for transmitting the metadata and the data via a same channel using a set of symbols modulated according to the second modulation scheme.

Aspect 5: The method, apparatus, or non-transitory computer-readable medium of aspect 4, further including operations, features, circuitry, logic, means, or instructions, or any combination thereof for identifying a mapping between the metadata and a symbol of the set of symbols, where transmitting the metadata is based at least in part on the mapping.

Aspect 6: The method, apparatus, or non-transitory computer-readable medium of any of aspects 4 through 5, where transmitting the metadata and the data includes operations, features, circuitry, logic, means, or instructions, or any combination thereof for transmitting a first subset of the set of symbols representative of the metadata prior to transmitting a second subset of the set of symbols representative of the data.

Aspect 7: The method, apparatus, or non-transitory computer-readable medium of any of aspects 1 through 6, further including operations, features, circuitry, logic, means, or instructions, or any combination thereof for reallocating resources associated with the metadata based at least in part on the metadata including an indication that the data is invalid.

Aspect 8: The method, apparatus, or non-transitory computer-readable medium of any of aspects 1 through 7, where a third quantity of the first subset of the second set of codewords associated with the second modulation scheme is equal to the first quantity of codewords associated with the first modulation scheme.

Aspect 9: The method, apparatus, or non-transitory computer-readable medium of aspect 8, where a fourth quantity of the second subset of the second set of codewords associated with the second modulation scheme is equal to a difference between the second quantity of codewords and the third quantity of codewords and the second subset of the second set of codewords includes unassigned codewords corresponding to the second modulation scheme.

Aspect 10: The method, apparatus, or non-transitory computer-readable medium of any of aspects 1 through 9, where the first modulation scheme includes a binary-symbol modulation scheme and the second modulation scheme includes a ternary-symbol modulation scheme.

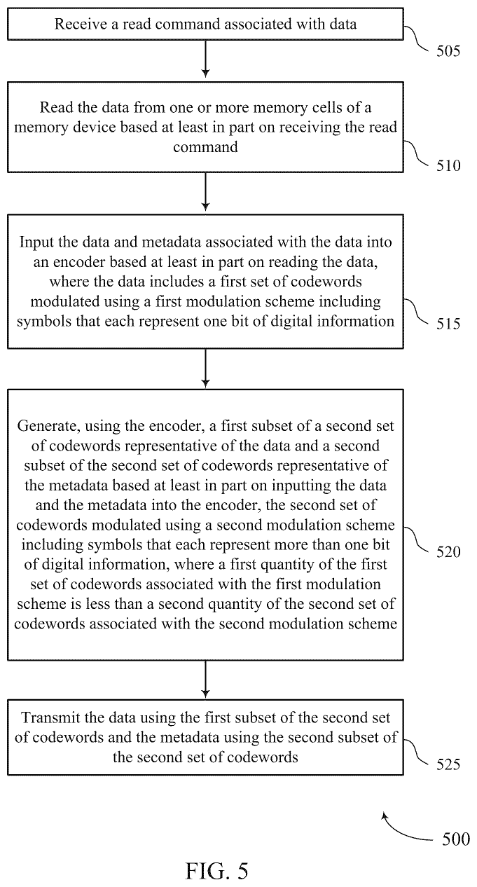

FIG. 5 shows a flowchart illustrating a method 500 that supports metadata transfer using unassigned codes of an encoder in accordance with examples as disclosed herein. The operations of method 500 may be implemented by a memory system or a host system or its components as described herein. For example, the operations of method 500 may be performed by a memory system or a host system as described with reference to FIGS. 1 through 3. In some examples, a memory system or a host system may execute a set of instructions to control the functional elements of the device to perform the described functions. Additionally, or alternatively, the memory system or the host system may perform aspects of the described functions using special-purpose hardware.

At 505, the method may include receiving a read command associated with data. In some examples, aspects of the operations of 505 may be performed by a read command component 340 as described with reference to FIG. 3.

At 510, the method may include reading the data from one or more memory cells of a memory device based at least in part on receiving the read command. In some examples, aspects of the operations of 510 may be performed by a read command component 345 as described with reference to FIG. 3.

At 515, the method may include inputting the data and metadata associated with the data into an encoder based at least in part on reading the data, where the data includes a first set of codewords modulated using a first modulation scheme including symbols that each represent one bit of digital information. In some examples, aspects of the operations of 515 may be performed by an input codeword component 325 as described with reference to FIG. 3.

At 520, the method may include generating, using the encoder, a first subset of a second set of codewords representative of the data and a second subset of the second set of codewords representative of the metadata based at least in part on inputting the data and the metadata into the encoder, the second set of codewords modulated using a second modulation scheme including symbols that each represent more than one bit of digital information, where a first quantity of the first set of codewords associated with the first modulation scheme is less than a second quantity of the second set of codewords associated with the second modulation scheme. In some examples, aspects of the operations of 520 may be performed by an encoding component 330 as described with reference to FIG. 3.

At 525, the method may include transmitting the data using the first subset of the second set of codewords and the metadata using the second subset of the second set of codewords. In some examples, aspects of the operations of 525 may be performed by an output codeword component 335 as described with reference to FIG. 3.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, that can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or a processor.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
inputting data and metadata associated with the data into an encoder, wherein the data comprises a first set of codewords modulated using a first modulation scheme comprising symbols that each represent one bit of digital information;
generating, using the encoder, a first subset of a second set of codewords representative of the data and a second subset of the second set of codewords representative of the metadata based at least in part on inputting the data and the metadata into the encoder, the second set of codewords modulated using a second modulation scheme comprising symbols that each represent more than one bit of digital information, wherein a first quantity of the first set of codewords associated with the first modulation scheme is less than a second quantity of the second set of codewords associated with the second modulation scheme; and
transmitting the data using the first subset of the second set of codewords and the metadata using the second subset of the second set of codewords.

2. The method of claim 1, further comprising:
receiving a read command associated with the data; and
reading the data from one or more memory cells of a memory device based at least in part on receiving the read command, wherein inputting the data and the metadata into the encoder is based at least in part on reading the data.

3. The method of claim 1, further comprising:
detecting one or more errors in the data based at least in part on performing an error control operation on the data; and
generating the metadata based at least in part on detecting the one or more errors in the data, wherein the metadata indicates that the data is invalid.

4. The method of claim 1, wherein transmitting the metadata and the data comprises:
transmitting the metadata and the data via a same channel using a set of symbols modulated according to the second modulation scheme.

5. The method of claim 4, further comprising:
identifying a mapping between the metadata and a symbol of the set of symbols, wherein transmitting the metadata is based at least in part on the mapping.

6. The method of claim 4, wherein transmitting the metadata and the data comprises:
transmitting a first subset of the set of symbols representative of the metadata prior to transmitting a second subset of the set of symbols representative of the data.

7. The method of claim 1, further comprising:
reallocating resources associated with the metadata based at least in part on the metadata comprising an indication that the data is invalid.

8. The method of claim 1, wherein a third quantity of the first subset of the second set of codewords associated with the second modulation scheme is equal to the first quantity of codewords associated with the first modulation scheme.

9. The method of claim 8, wherein a fourth quantity of the second subset of the second set of codewords associated with the second modulation scheme is equal to a difference between the second quantity of codewords and the third quantity of codewords, and wherein the second subset of the second set of codewords comprises unassigned codewords corresponding to the second modulation scheme.

10. The method of claim 1, wherein the first modulation scheme comprises a binary-symbol modulation scheme and the second modulation scheme comprises a ternary-symbol modulation scheme.

11. A non-transitory computer-readable medium storing code, the code comprising instructions executable by a processor to:
input data and metadata associated with the data into an encoder, wherein the data comprises a first set of codewords modulated using a first modulation scheme comprising symbols that each represent one bit of digital information;
generate, using the encoder, a first subset of a second set of codewords representative of the data and a second subset of the second set of codewords representative of the metadata based at least in part on inputting the data and the metadata into the encoder, the second set of codewords modulated using a second modulation scheme comprising symbols that each represent more than one bit of digital information, wherein a first quantity of the first set of codewords associated with the first modulation scheme is less than a second quantity of the second set of codewords associated with the second modulation scheme; and
transmit the data using the first subset of the second set of codewords and the metadata using the second subset of the second set of codewords.

12. The non-transitory computer-readable medium of claim 11, wherein the instructions are further executable by the processor to:
receive a read command associated with the data; and
read the data from one or more memory cells of a memory device based at least in part on receiving the read command, wherein inputting the data and the metadata into the encoder is based at least in part on reading the data.

13. The non-transitory computer-readable medium of claim 11, wherein the instructions are further executable by the processor to:
detect one or more errors in the data based at least in part on performing an error control operation on the data; and
generate the metadata based at least in part on detecting the one or more errors in the data, wherein the metadata indicates that the data is invalid.

14. The non-transitory computer-readable medium of claim 11, wherein the instructions to transmit the metadata and the data are executable by the processor to:
transmit the metadata and the data via a same channel using a set of symbols modulated according to the second modulation scheme.

15. The non-transitory computer-readable medium of claim 11, wherein the instructions are further executable by the processor to:
reallocate resources associated with the metadata based at least in part on the metadata comprising an indication that the data is invalid.

16. An apparatus, comprising: a controller associated with a device, wherein the controller is configured to cause the apparatus to:
input data and metadata associated with the data into an encoder, wherein the data comprises a first set of codewords modulated using a first modulation scheme comprising symbols that each represent one bit of digital information;
generate, using the encoder, a first subset of a second set of codewords representative of the data and a second subset of the second set of codewords representative of the metadata based at least in part on inputting the data and the metadata into the encoder, the second set of codewords modulated using a second modulation scheme comprising symbols that each represent more than one bit of digital information, wherein a first quantity of the first set of codewords associated with the first modulation scheme is less than a second quantity of the second set of codewords associated with the second modulation scheme; and
transmit the data using the first subset of the second set of codewords and the metadata using the second subset of the second set of codewords.

17. The apparatus of claim 16, wherein the controller is further configured to cause the apparatus to:
receive a read command associated with the data; and
read the data from one or more memory cells of a memory device based at least in part on receiving the read command, wherein inputting the data and the metadata into the encoder is based at least in part on reading the data.

18. The apparatus of claim 16, wherein the controller is further configured to cause the apparatus to:
detect one or more errors in the data based at least in part on performing an error control operation on the data; and
generate the metadata based at least in part on detecting the one or more errors in the data, wherein the metadata indicates that the data is invalid.

19. The apparatus of claim 16, wherein transmitting the metadata and the data is configured to cause the apparatus to:
transmit the metadata and the data via a same channel using a set of symbols modulated according to the second modulation scheme.

20. The apparatus of claim 16, wherein the controller is further configured to cause the apparatus to:
reallocate resources associated with the metadata based at least in part on the metadata comprising an indication that the data is invalid.
